(19) United States
(12) Patent Application Publication
(10) Pub. No.: US 2023/0002586 A1
(43) Pub. Date: Jan. 5, 2023

(54) PITCH COMPOSITIONS, METHODS AND USES THEREOF

(71) Applicant: TOTALENERGIES ONETECH, Courbevoie (FR)

(72) Inventors: Olivier GAMET, Bailly Romainvilliers (FR); Mouhamad MOUAZEN, Nanterre (FR); Stefan OEST, Itzehoe (DE)

(73) Assignee: TOTALENERGIES ONETECH, Courbevoie (FR)

(21) Appl. No.: 17/781,540

(22) PCT Filed: Dec. 18, 2020
(86) PCT No.: PCT/FR2020/052534

§ 371 Date: Jun. 1, 2022

(30) Foreign Application Priority Data
Dec. 20, 2019 (FR) FR1915214

(51) Int. Cl. C08K 3/22; C08J 3/20; C09D 195/00; C09D 5/00; C04B 26/26; E01C 7/30

(52) U.S. Cl. CPC C08K 3/22; C08J 3/203; C09D 195/00; C09D 5/00; C04B 26/26; E01C 7/30; C08J 2395/00; C08J 2495/00; C04B 2111/0075

(57) ABSTRACT

The present invention relates to a pitch composition comprising a mixture of:
deasphalting pitch, which represents at least 50% by weight, and preferably at least 80% by weight, and preferentially at least 90% by weight, of the total weight of the composition, and
a hydroxide XOH with X=Na or K, which represents from 0.001 to 1% by weight, of the total weight of the composition,
   as well as the method of preparation and uses thereof, particularly in the field of road construction.

### TECHNICAL FIELD

The present invention relates to the technical field of binders that can replace bitumen, particularly in the field of road construction. More specifically, the invention relates to pitch compositions, methods for their preparation and their use in road and industrial applications.

A deasphalting pitch can be incorporated into bitumen compositions, in a mixture with a bitumen base. The deasphalting pitch constitutes an economical component which gives the composition hardness. However, the main defect of deasphalting pitch is its low penetration index defined in standard EN 1427-Appendix B, which is below −1.5, making it highly sensitive to temperature contrary to standard bitumen. Pitches thus do not correspond to the road construction requirements defined in standard EN 12591 and EN 13924-1, particularly standard EN 12591. Moreover, a deasphalting pitch is more sensitive to oxidation compared to standard bitumen, due to its higher content in asphaltene. When it is incorporated into a bitumen composition, this is generally in a limited quantity, usually not exceeding 20 to 30% by weight, with respect to the total weight of the composition. In the case where it is mixed with an oxidised bitumen base, a higher content, possibly reaching 75% by weight of the total composition, can be adopted.

Within the scope of the invention, the applicant proposes novel pitch compositions which are adapted to act as binders, particularly in the field of road construction, and, in particular, which can be used to manufacture mixes or asphalts.

The pitch compositions according to the invention could therefore constitute a substitute for bitumen compositions, which would be particularly advantageous in the case of bitumen shortages. In addition, within the context of the decision by the World Maritime Organisation to reduce in 2020 the maximum sulphur limit in maritime fuels to 0.5% by weight, the available pitch tonnage could increase and the invention would be a new way of upgrading deasphalting pitches.

Invention

In this context, the inventors have developed new pitch compositions which have an elevated penetration index, measured according to standard EN 1427-Appendix B, compared to the same pitch compositions which do not contain sodium hydroxide.

The invention relates to a pitch composition comprising a mixture of:
deasphalting pitch, which represents at least 50% by weight, and preferably at least 80% by weight, and preferentially at least 90% by weight, of the total weight of the composition, and
a hydroxide XOH with X=Na or K, which represents from 0.001 to 1% by weight, preferably from 0.002 to 0.5% by weight, and preferentially from 0.01 to 0.5% by weight of the total weight of the composition.

Advantageously, a composition according to the invention has one of the following characteristics, several of the following characteristics, if not all of the following characteristics:
the hydroxide XOH, with X=Na or K, forms particles which have a mean maximum size in the range from 10 to 100 μm, preferably in the range from 20 to 60 μm and/or which have a maximum size less than or equal to 100 μm, preferably less than or equal to 60 μm;
the hydroxide XOH is soda;
it has a penetration index determined according to standard EN 1427-Appendix B, greater than −1.5, preferably greater than or equal to −1.3;
it has needle penetration at 25° C., determined according to standard EN 1426, which falls in the range from 0 to 50 mm/10 and/or a ball and ring softening temperature, determined according to standard EN 1427, which falls in the range from 50 to 175° C.;
it moreover comprises a hydrocarbonated component CH, chosen from among hydrocarbonated oils, soft-grade bitumen, fluxed bitumen, fluidified bitumen, and mixtures thereof, said hydrocarbonated component CH preferably representing at the most 10% by weight, preferentially 0.1 to 10% by weight, in a more preferred manner 0.5 to 8% by weight, and even more preferably 1 to 5% by weight, of the total weight of the composition.

An objective of the invention is also a method for the preparation of a pitch composition, comprising the following steps:

a—having an initial pitch composition available, and
b—incorporating a hydroxide XOH with X=Na or K, in an amount such that the amount of hydroxide XOH introduced represents 0.001 to 1% by weight, of the total weight of the final pitch composition obtained,
the initial pitch composition comprising an amount such that the pitch represents at least 50% by weight, preferably at least 80% by weight, and preferably at least 90% by weight, of the total weight of the final pitch composition obtained.

In the method according to the invention, advantageously, in step b, a hydrocarbonated composition IC comprising 15 to 50% by weight of hydroxide XOH with X=Na or K is incorporated into the initial pitch composition, said composition IC, comprising a hydrocarbonated component CH, preferably chosen from among hydrocarbonated oils, soft-grade bitumen, fluxed bitumen, fluidified bitumen and mixtures thereof.

According to a preferred embodiment, in the method according to the invention, the hydroxide XOH, with X=Na or K, is present in the composition IC, in the form of particles which have a mean maximum size in the range from 10 to 100 μm, preferably in the range from 20 to 60 μm and/or which have a maximum size less than or equal to 100 μm, preferably less than or equal to 60 μm.

Advantageously, incorporation of the hydrocarbonated composition IC into the initial pitch composition is carried out at a temperature in the range from 150 to 220° C., preferably in the range from 160 to 190° C. and/or with stirring in the range from 100 to 500 rpm, preferably in the range from 200 to 400 rpm, for a period of 10 to 180 minutes, preferably from 10 to 20 minutes.

An objective of the invention is also the use of a hydroxide XOH with X=Na or K, in a composition which comprises pitch representing at least 50% by weight, preferably at least 80% by weight, and preferentially at least 90% by weight, of the total weight of the composition, in which the hydroxide XOH with X=Na or K is introduced into the composition, in an amount representing from 0.001 to 1% by weight, preferably from 0.002 to 0.5% by weight, and preferentially from 0.01 to 0.5% by weight, of the total weight of the composition, to increase the penetration index determined according to standard EN 1427-Appendix B of the composition obtained, and to obtain, in particular, a penetration index greater than −1.5, preferably greater than or equal to −1.3, the % by weight given for pitch and hydroxide being calculated relative to the total weight of the composition including the hydroxide.

The invention also relates to the use of a composition according to the invention, to prepare waterproof coating, a membrane or seal layer.

A method for the preparation of a mix comprising hot mixing of a composition according to the invention, with aggregates, and possibly mineral and/or synthetic fillers, as well as a mix comprising a composition according to the invention, mixed with aggregates, and possibly mineral and/or synthetic fillers, are also an integral part of the invention.

The invention also relates to a method for the preparation of asphalt comprising hot mixing of a composition according to the invention, with mineral and/or synthetic fillers, as well as asphalts comprising a composition according to the invention, mixed with mineral and/or synthetic fillers.

An objective of the invention is also the use of a composition according to the invention, to prepare a surface coat, a hot mix, cold mix, cold-poured mix, grave-emulsion or rolling layer, said composition being associated with aggregates and/or recycled milled material.

The invention will be better understood from the detailed description which follows.

### Definitions

Within the scope of the invention, the terms «to comprise» or «to include» and their variations «comprises», «includes», «comprising», «including» do not exclude the presence of one or several elements or steps of a method other than that or those specified. Nevertheless, unless understood otherwise from the context, the terms «comprise» or «include» and variations signify «to consist exclusively of» or its corresponding variation.

Within the scope of the invention, when it relates to a hydroxide XOH, this means at least one hydroxide XOH (NaOH or KOH) and therefore a single hydroxide NaOH or KOH, as well as a mixture of NaOH and KOH hydroxides; when reference is made to a hydrocarbonated components, it should be understood at least one hydrocarbonated component and therefore this includes a single hydrocarbonated component, as well as several hydrocarbonated components; when reference is made to the description or the invention, this includes equally a single aspect or several aspects, such as described in the present description. The different aspects described in the present text are included under the term «invention».

Thus, in particular, when reference is made of a hydroxide XOH, a hydrocarbonated compound, a pitch or soft bitumen, this includes a single one of these elements or combination of a mixture of one or more of these elements.

Nevertheless, preferentially, these terms designate a single one of these elements.

In the present text, «hydroxide» and «hydroxide XOH» are used interchangeably and designate NaOH, KOH and mixtures thereof.

Similarly, «deasphalting pitch» and «pitch» are used interchangeably.

In the present text, unless otherwise specified, when a standard is referred to, the latter refers to the most recent version of this standard available on 1 Dec. 2019.

### Pitch

Deasphalting pitches are derived from the residues of the vacuum distillation of petroleum. Deasphalting pitches, also called pitches within the scope of the invention for reasons of simplicity, present characteristics that differ from those of bitumen, particularly in terms of penetration index and, consequently, do not belong to the bitumen class.

A deasphalting pitch can be obtained by the usual methods applied in oil refineries. During refining processes, petroleum is subjected to a succession of atmospheric distillations and distillations under reduced pressure (commonly known as vacuum distillation). The distillation under atmospheric pressure and distillation under reduced pressure, used in petroleum refining are known to the person skilled in the art, as reported in the field of the invention presentation. All distillation processes under atmospheric pressure, leading to a distillation residue under atmospheric pressure and all distillation processes under reduced pressure, and leading to a residue of distillation under reduced pressure (or under vacuum) can be used.

Conventionally, to begin with, petroleum is subjected to distillation under atmospheric pressure (i.e. at 1013.25 hPa), which produces a gas phase, various distillates and a residue of atmospheric distillation. This first distillation step makes it possible to recover various hydrocarbon fractions (gas: butane and propane, light petroleum, heavy naphtha, kerosene, gasoil, domestic fuel, . . . ) separated according to their boiling point. Atmospheric distillation is carried out in a plate column. At the end of this distillation under atmospheric pressure, there remains a heavy residual fraction, which is called the atmospheric residue or the atmospheric distillation residue. This atmospheric residue contains long-chain hydrocarbons which, due to this, are fragile and therefore likely to be cleaved into smaller chains, if heating is carried out under atmospheric pressure. Next, the atmospheric distillation residue itself is subjected to distillation under reduced pressure, called vacuum distillation, which makes it possible to separate heavy diesel, various distillate cuts and a vacuum distillation residue. The reduced pressure used for this second distillation is, in general, in the range from 10 to 150 hPa. Such reduced pressure reduces the temperature at which components evaporate, and thus allows heating to be reduced. Distillation under reduced pressure is also carried out in plate column or packed column, or a dual system combining these columns. At the end of this vacuum distillation step, there remains a heavy residual fraction, which is called the vacuum distillation residue, or the reduced pressure distillation residue. This vacuum distillation residue contains variable concentrations of the deasphalting pitch.

It is possible to recover the deasphalting pitch according to the following process.

The vacuum distillation residue undergoes a deasphalting process by addition of a suitable solvent, for example an alkane such as propane, which thus makes it possible to precipitate the pitch and to separate light fractions such as deasphalted oil. Advantageously, the deasphalting process is carried out at a temperature between 30° C. and 200° C., preferably from 35° C. to 90° C. and at a pressure between 0.7 MPa and 7 MPa, preferably from 2 to 5 MPa, in a most preferred manner from 2 to 4 MPa.

Preferably, the deasphalting pitch according to the invention, presents needle penetration at 25° C. of 0 to 45 1/10 mm, preferably from 1 to 40 1/10 mm, preferentially from 1 to 30 1/10 mm, even more advantageously from 5 to 25 1/10 mm, it being understood that penetration is measured according to standard EN 1426.

Preferably, the deasphalting pitch according to the invention has a ball and ring softening temperature (BRT) comprised between 50° C. and 175° C., preferably from 50° C. to 140° C., preferentially from 50° C. to 90° C. and even more advantageously from 50° C. to 65° C., BRT being measured according to standard EN 1427.

Preferably, the deasphalting pitch according to the invention has a Conradson carbon ratio (CCR) of 15 to 55%, preferably from 25 to 35%, preferentially from 25 to 30%. The Conradson carbon ratio (CCR) can be measured according to standard NF ISO 6615: (Petroleum products—Determination of carbon residue—Conradson Method). Preferably, the deasphalting pitch according to the invention has a density of d25° C. defined according to standard EN 15326 in the range from 1.05 to 1.15, preferably in the range from 1.05 to 1.10, preferentially in the range from 1.06 to 1.10.

Preferably, the deasphalting pitch according to the invention has a PAH (Polycyclic Aromatic Hydrocarbons) content measured by GC-MS (gas chromatography coupled with mass spectrometry) less than or equal to 100 ppm, preferably less than 50 ppm. This measurement is carried out on the list of 16 PAHs classed as a priority by the US-EPA («United States Environmental Protection Agency»).

Within the scope of the invention, any kind of deasphalting pitch obtained from vacuum distillation residues of petroleum by precipitation by an alkane, in particular propane, can be used.

The deasphalting pitches have a penetration index determined according to standard EN 1427-Appendix B, generally less than −1.5.

### Hydroxide

The invention relates to pitch compositions modified by the incorporation of a hydroxide XOH in which X=Na or K, with preferably X=Na.

Within the scope of the invention, when it relates to «hydroxide XOH» or «hydroxide», this means a hydroxide XOH in which X=Na or K, with preferably X=Na (which corresponds to soda).

Within the scope of the invention, a hydroxide XOH with X=Na or K, is used in a composition which includes a pitch to increase the penetration index of the pitch composition obtained. With regard to the penetration index in the scope of the invention, this is determined according to standard EN 1427-Appendix B. In said pitch compositions obtained by incorporation of hydroxide, the pitch represents at least 50% by weight, preferably at least 80% by weight, and preferentially at least 90% by weight, of the total weight of the composition, and the hydroxide is added to the composition, in an amount representing from 0.001 to 1% by weight, preferably 0.002 to 0.5% by weight, and preferentially from 0.01 to 0.5% by weight, of the total weight of the pitch composition obtained. The amount of hydroxide added is such that the pitch composition obtained has, advantageously, a penetration index greater than or equal to −1.5, preferably greater than or equal to −1.3, preferentially greater than or equal to −1.2. In a preferred manner, the penetration index is less than 5, preferably less than 1, and preferentially in the range from −1.3 to 1. The hydroxide can thus be used to modify any pitch composition, whether this composition comprises pitch only or whether it includes an additive envisaged within the scope of the invention.

In particular, the hydroxide XOH, can be used in the form of a hydrocarbonated composition IC comprising a hydrocarbonated component CH and the hydroxide XOH. A hydrocarbonated composition IC will, preferably, consist exclusively of a mixture of the hydroxide XOH and a hydrocarbonated component CH. Advantageously, the hydroxide XOH is found in such a hydrocarbonated composition IC in the form of particles with at least 80% by number of said particles having a maximum size in the range from 10 to 100 μm, preferably in the range from 20 to 60 μm. Such a particle size allows better control and optimum adjustment of the properties of the pitch composition obtained. The maximum size of a particle which, in general, has an irregular form, corresponds to its greatest dimension, in particular, measured with microscope, and preferably a visible light microscope. When a hydrocarbonated composition IC is used, the hydroxide XOH represents, advantageously from 15 to 50% by weight, in particular from 15 to 25% by weight, of the weight of said hydrocarbonated composition IC. Such a hydrocarbonated composition IC is, therefore, incorporated into the pitch composition.

### Hydrocarbonated Component

In the pitch compositions according to the invention, the hydroxide XOH, can be added, through the intermediary of a hydrocarbonated composition IC comprising in addition to the hydroxide XOH a hydrocarbonated component CH. In such cases, the hydrocarbonated component CH is therefore also found in the pitch composition according to the invention. In particular, a pitch composition according to the invention comprises a hydrocarbonated component CH, in particular chosen from among hydrocarbonated oils, soft-grade bitumen, fluxed bitumen, fluidified bitumen, and mixtures thereof, said hydrocarbonated component CH preferably representing at the most 10% by weight, preferentially 0.1 to 10% by weight, in a most preferred way 0.5 to 8% by weight, and in an even more preferred way 1 to 5% by weight, of the total weight of the pitch composition according to the invention.

In the present invention, by “hydrocarbonated component” is meant a hydrocarbon, or a component comprising a hydrocarbon, or a compound comprised essentially of a hydrocarbon or a mixture of hydrocarbons. A hydrocarbon is made up entirely of hydrogen and carbon atoms, said compound being saturated or unsaturated, cyclic or acyclic. The alkanes, cycloalkanes, alkenes, alkynes and aromatic hydrocarbons, particularly the arenes, are different examples of hydrocarbons. As preferred examples of a hydrocarbonated component CH that can be used within the scope of the invention, one can cite hydrocarbonated oils and bitumen. The hydrocarbonated component is not a deasphalting pitch.

Advantageously, the hydrocarbonated component CH is bitumen, preferably a soft-grade bitumen such as defined in standard EN 12591 (version 2009), for example under the reference V1500, V3000, V6000 or V12000; or a fluxed or fluidified bitumen such as that defined in standard EN 15322 (version 2013), for example reference Fm 3-225 X 0, Fm 4-75 X 0, Fm 4-150 X 0, Fm 4-300 X 0, Fm 8 x 0, Fv 3-30 X 0, Fv 3-60 X 0, Fv 3-120 X 0, Fv 5-60 X 0, Fv 5-180 X 0, Fv 8 x 0 or Fv 9 x 0.

Other adapted examples of a hydrocarbonated component CH that can be used within the scope of the invention, other than bitumen, are hydrocarbonated oils. Such oils can be mineral oils, synthetic oils, fluxed oils, alkanes, such as TOTAL cylinder oil 1000 N. When an oil is used, it is preferably neutral or basic.

The hydrocarbonated component CH has, preferably, a kinematic viscosity at 60° C. in the range from 50 to 20,000 mm²/s, preferably in the range from 50 to 150 mm²/s. Such a kinematic viscosity may be measured according to standard EN 12595. With such viscosity, the hydrocarbonated composition IC comprising the hydroxide XOH and the hydrocarbonated component CH may be prepared with conventional stirrers, in particular blade stirrers.

According to another advantageous feature, the hydrocarbonated component CH has a transmittance of light at a wavelength of 900 nm of at least 0.03%. This transmittance can be measured using a photometer such as the Hach Lange DR 3900, photometer in particular with a 1 cm optical glass cuvette. With such transmittance, it is possible to verify, in particular by microscopy under visible light, that the hydroxide XOH is found in the form of particles in the hydrocarbonated composition IC, and to verify the size of said particles. In particular, it will be verified that the hydroxide XOH is found in the composition IC in the form of particles with a mean maximum size less than or equal to 100 μm, preferably less than or equal to 60 μm and in particular that they have a mean maximum size in the range from 10 to 100 μm, preferably in the range from 20 to 60 μm.

### Additive(s)

The pitch compositions according to the invention may comprise exclusively deasphalting pitch and a hydroxide XOH such as described within the scope of the invention, may be exclusively comprised of a deasphalting pitch, a hydroxide XOH and a hydrocarbonated component CH such as described within the scope of the invention, or may also include one or several additives.

In particular, if the hydroxide XOH is introduced via the intermediary of a hydrocarbonated composition IC comprising a hydrocarbonated component CH, the pitch composition according to the invention will include such a hydrocarbonated component CH.

Thus, the invention relates to pitch compositions which comprise, in addition to pitch and the hydroxide, a hydrocarbonated component CH, preferably chosen from among hydrocarbonated oils, soft-grade bitumen, fluxed bitumen, fluidified bitumen and mixtures thereof, particularly those described in the «Hydrocarbonated component» section.

In general, said hydrocarbonated component CH represents, preferably, at most 10% by weight, preferentially 0.1 to 10% by weight, in a more preferred manner 0.5 to 8% by weight, and in an even more preferred manner 1 to 5% by weight, of the total weight of the pitch composition.

Moreover, the pitch compositions according to the invention can include one or several additives, whose incorporation has already been described for bitumen compositions.

In particular, the pitch compositions according to the invention can also include an adhesion promoter, namely chosen from among amines, diamines, polyamines, alkyl amido amines, amidopolyamines, imidazolines, and mixtures thereof. Such adhesion promoters are described, in particular, in application WO 2018/206489 which can be referred to for more details.

In particular, such an adhesion promoter is chosen from among:

i) Amines of formula (I):

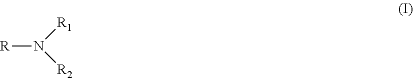

wherein:
   R is a saturated or unsaturated, substituted or unsubstituted, optionally branched or cyclic, hydrocarbon radical with 8 to 24 carbon atoms, for example derived from tallow fatty acids, or tall oil fatty acids; and
R₁ and R₂ can be the same or different and are selected from hydrogen atom or hydrocarbon radical with 1 to 24 carbon atoms; R₁ and R₂ are preferably selected from a hydrogen atom or methyl group;
   ii) Diamines and polyamines of formula (II):

R—(NH-L)n-NH₂ (II)
wherein:
R has the same meaning as in (I) above,
L represents a linear or branched hydrocarbon radical with 1 to 6 carbon atoms, for instance L is —(CH₂)ₘ— with m=1, 2 or 3 and,
n is an integer greater than or equal to 1, in particular n is an integer equal to 1, 2, 3, 4, 5 or 6;
   iii) Alkyl amido amines of formula (III):

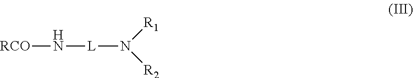

wherein R, R₁, R₂ and L have the same meaning as in (I) and (II), above;
iii) Alkyl amido amines of formula (III):

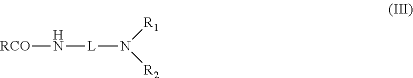

wherein R, R₁, R₂ and L have the same meaning as in (I) and (II), above;
   iv) Amidopolyamines of formula (IV) and imidazolines:

RCO—(NH-L)ₚ-NH₂ (IV)

wherein R and L have the same meaning as in (I) and (II) above, and p is an integer greater than or equal to 1, in particular p is an integer from 1 to 10.

Advantageously, the amine additive is selected from amines, diamines, polyamines, alkyl amido amines and amidopolyamines including a fatty chain. According to a specific embodiment, the amine additive is an amidopolyamine including a fatty chain of formula:

RCO—[NH-L]p-NH₂ (IV)

where:
p is an integer greater than or equal to 1, in particular p is an integer from 1 to 10,
L is a linear or branched hydrocarbon chain with 1 to 6 carbon atoms, for example
L is —(CH₂)ₘ— with m=1, 2 or 3,
R is a saturated or unsaturated, substituted or unsubstituted, optionally branched hydrocarbon radical with 8 to 24 carbon atoms.

In a preferred manner, the adhesion promoter used in the pitch compositions according to the invention is a mixture of amidopolyamines of formula (IV) in which p is an integer in the range from 1 to 10, L is —(CH₂)₂—, and R corresponds to the hydrocarbonated chains of tall oil fatty acids.

In general, when it is present, said adhesion promoter represents, preferably, 0.01 to 2% by weight, preferentially 0.05% to 1% by weight, and in an even more preferred way 0.1 to 0.3% by weight, of the total weight of the pitch composition according to the invention.

It is also possible to include, as is done, in certain bitumen compositions, one or more polymers.

The pitch compositions according to the invention may include an agent (called a temperature reducing agent) allowing a reduction in the temperature at which pitch compositions according to the invention can be used in a satisfactory manner, as a binder. As an example of a temperature reducer, mention can be made as an example, of derivatives of tall oil, taken alone or in combination with a monoester of a mixture of fatty acids, such as those described in document WO 2010/134024. Mention can also be made, as suitable additives according to the invention, of the additives described in document WO 2012/049579 and in document WO 2014/095995. Preferably, agents in particular those sold by Arkema, are used, under the reference Cecabase RT bio 10, in particular.

In general, when it is present, said temperature reducer represents, preferably, 0.01 to 3% by weight, and preferentially 0.05 to 0.3% by weight, of the total weight of the composition according to the invention.

### Method for the Preparation of Pitch Compositions According to the Invention

The pitch compositions according to the invention can be prepared by any suitable method, known to the person skilled in the art. As a general rule, these methods include mixing the components and heating the mixture.

The hydroxide can be introduced directly into an initial pitch composition, directly in the form of a powder or in the form of a solution in a suitable solvent. Mention can be made of water and methanol as examples of suitable solvents. The hydroxide may be present in such a solution, for instance at a concentration from 10 to 50% by weight, relative to the total weight of the solution. A suitable solvent will preferably have a boiling point less than or equal to 100° C. at 1013.3 hPa. It will be chosen preferably such that it evaporates spontaneously when the hydroxide solution is incorporated into the initial pitch composition.

Whether it is introduced directly in the form of a powder or a solution in a solvent, the amount introduced is chosen so as to finally obtain in the pitch composition according to the invention, an amount of hydroxide which represents from 0.001 to 1% by weight, preferably 0.002 to 0.5% by weight, and preferentially from 0.01 to 0.5% by weight, of the total weight of the pitch composition obtained.

Advantageously, the hydroxide is introduced into an initial pitch composition, in the form of a particle powder with a maximum size less than or equal to 100 μm, preferably less than or equal to 60 μm. In a still more preferred manner, the hydroxide is introduced, in an initial pitch composition, in the form of a particle powder with a maximum size in the range from 10 to 100 μm, preferably from 20 to 60 μm. An anhydrous powder is used preferably. The mean maximum size of particles corresponds to the arithmetic mean of the maximum sizes of a set of particles, preferably at least 20 particles, and especially 20 particles. The maximum size can be measured by microscopy. The size of particles introduced can be adjusted by different techniques, in particular by grinding and/or sieving.

According to a preferred embodiment, the hydroxide, in particular, in the form of particles, is introduced by means of a hydrocarbonated composition IC.

Such a hydrocarbonated composition IC comprises, or is even constituted exclusively of, the hydroxide distributed in a hydrocarbonated component CH such as that described previously.

In particular, the hydroxide represents, preferably, 15 to 50% and preferentially 15 to 25% by weight, of the total weight of the hydrocarbonated composition IC. Similarly, to what is described in the case of direct introduction of the hydroxide into the initial pitch composition, the hydroxide can be introduced in the hydrocarbonated component CH, directly in the form of a powder or in solution in a suitable solvent. However, advantageously, the hydroxide is introduced, in the hydrocarbonated composition K, in the form of a particle powder with a maximum size less than or equal to 100 μm, preferably less than or equal to 60 μm. Even preferentially, the hydroxide can be introduced in the hydrocarbonated component CH, directly in the form of a powder or in solution in a suitable solvent. However, advantageously, the hydroxide is introduced, in the hydrocarbonated composition IC, in the form of a particle powder with a mean maximum size in the range from 10 to 100 μm, preferably from 20 to 60 μm.

Advantageously, the hydrocarbonated component CH, of the hydrocarbonated composition IC, has a transmittance of light, at a wavelength of 900 nm, of at least 0.03%. This transmittance can be measured using a photometer such as the Hach Lange DR 3900 photometer in particular with a 1 cm optical glass cuvette. With such transmittance, it is possible to verify by microscopy, in particular by microscopy under visible light, that the hydroxide does actually form particles in the hydrocarbonated composition IC. In general, when the hydroxide is incorporated into the hydrocarbonated composition IC, in the form of particles of a given size, this size is preserved or at least substantially preserved in the hydrocarbonated composition IC. Most often, in the powder as well as in the hydrocarbonated composition IC, the hydroxide particles are not spherical and have irregular shapes. When it concerns the size of particles within the scope of the invention, what is meant is the maximum size which corresponds to the largest dimension which can be measured, especially with a microscope. This size can be measured directly from the composition IC, if the transmittance of the hydrocarbonated component CH is sufficient.

In particular in the hydrocarbonated composition IC, the hydroxide forms particles of which at least 80% by number have a maximum size in the range from 10 to 100 μm, preferably, in the range from 20 to 60 μm and/or having a maximum size less than or equal to 100 μm, preferably less than or equal to 60 μm. In an even more preferred manner, the hydroxide XOH is found in the composition IC in the form of particles with a mean maximum size in in the range from 10 to 100 μm, preferably in in the range from 20 to 60 μm. On the other hand, the size of the hydroxide particles cannot be verified in the pitch composition according to the invention.

Moreover, the use of a hydrocarbonated composition IC comprising the hydroxide makes it possible to protect the hydroxide against humidity and to improve its storage, prior to its introduction into the initial pitch composition.

Advantageously, such a hydrocarbonated composition IC comprises a hydrocarbonated component with a kinematic viscosity at 60° C. measured according to EN 12595 in the range from 50 to 20,000 mm²/s, preferably in the range from 50 to 150 mm²/s. With such viscosities, the preparation of such a composition and the introduction of the hydroxide requires a conventional mixing device, such as blade stirrers.

In particular, the preparation of a hydrocarbonated composition IC may be carried out by mixing a hydrocarbonated component CH and the hydroxide at a temperature in the range from 30 to 220° C., preferably in the range from 40 to 190° C. and/or with stirring in the range from 300 to 800 rpm, preferably in in the range from 500 to 650 rpm and/or for a period of 10 to 120 minutes, preferably from 10 to 20 minutes. The mixing and temperature parameters will be adjusted by the person skilled in the art as a function of the selected hydrocarbonated component CH.

During preparation of such a hydrocarbonated composition IC, the hydrocarbonated component CH may be heated at a temperature at which it is found in the liquid state, in such a way as to promote the incorporation and distribution of the hydroxide. For example, a temperature that is just sufficient to obtain melting of the hydrocarbonated component CH can be used, in particular when the hydroxide is introduced in the form of a powder. When the hydroxide is introduced in the form of a solution in a solvent, preferably, the hydrocarbonated component CH will be subjected to suitable heating to achieve spontaneous evaporation of the solvent, simultaneously to incorporation of the hydroxide solution.

When the hydroxide is introduced through the intermediary of a hydrocarbonated composition IC, the amount present in this composition determines the amount of hydrocarbonated composition IC introduced. Indeed, this hydrocarbonated composition IC is introduced in an amount as in the initial pitch composition, in a manner to finally obtain in the pitch composition according to the invention, an amount of hydroxide which represents from 0.001 to 1% by weight, preferably from 0.002 to 0.5% by weight, and preferentially, from 0.01 to 0.5% by weight, of the total weight of the pitch composition obtained.

In general, the weight percentage of the hydroxide in the hydrocarbonated composition IC is at least 30 times equal to the weight percentage of the hydroxide in the final pitch composition and, preferably, at the most 100 times equal to the weight percentage of hydroxide in the final pitch composition according to the invention.

The method for preparation of the pitch compositions according to the invention can include the preparation of a hydrocarbonated composition IC, when such a composition is used to introduce hydroxide in the initial pitch composition. It is also possible that the method for preparation of pitch compositions according to the invention comprises a storage step of the hydrocarbonated composition IC for at least one hour and for example for a period of 1 to 30 days, particularly at a temperature in the range from 10 to 40° C. and, preferably, at a temperature in the range from 20 to 30° C., and, particularly in ambient air. The hydrocarbonated composition IC is fairly stable under such conditions, so that even the same hydrocarbonated composition IC with specific characteristics may be used for the preparation of several pitch compositions. Moreover, the hydrocarbonated composition IC can be stored and transported without particular precautions, contrary to the hydroxide XOH.

According to the embodiments, which can be combined with the preceding, before the addition of the hydroxide to the initial pitch composition, the method according to the invention can include a verification step, for example by microscopy, and advantageously by visible light microscopy, that the hydroxide forms particles in the hydrocarbonated composition IC with at least 80% by number of said particles having a mean maximum size in the range from 10 to 100 μm, and preferentially in the range from 20 to 60 μm and/or said particles having a maximum size less than or equal to 100 μm, preferably less than or equal to 60 μm. In an even more preferred manner, the method according to the invention can include a verification step, for example by microscopy, and advantageously by visible light microscopy, that the hydroxide XOH is found in the hydrocarbonated composition IC in the form of particles having a maximum size in the range from 10 to 100 μm, preferably in the range from 20 to 60 μm.

When an intermediary composition IC is used, before its introduction in the initial pitch composition, the hydrocarbonated composition IC will be, preferably, heated at a temperature in the range from 30 to 50° C., preferably in the range from 40 to 50° C., advantageously with stirring and, in particular, stirring at 300 to 1000 rpm, preferably stirring from 400 to 800 rpm and/or for a period of 10 to 120 minutes, preferably from 10 to 20 minutes. A low temperature, preferably 40 to 50° C., is also advantageous to promote control of the size of the particles of hydroxide XOH.

Such a temperature is, in particular, used when the component CH has a kinematic viscosity at 60° C. in the range from 20 to 20,000 mm²/s, preferably in the range from 50 to 150 mm²/s. Here again, the mixing and temperature are adjusted by the person skilled in the art as a function of the hydrocarbonated component CH selected.

Conventionally, the hydroxide, whether introduced directly in the form of a powder, solution or hydrocarbonated composition IC, is done so, in the initial pitch composition, with mixing and heating. In general, the initial pitch composition is heated with stirring, prior to incorporation of the hydroxide. The mixing and heating parameters will be adjusted by the person skilled in the art as a function of the properties of the pitch used.

The incorporation of hydroxide particles, whether this is in the form of a powder, a solution or a hydrocarbonated composition IC, may be carried out by mixing at a temperature in the range from 150 to 220° C., preferably at a temperature in the range from 160 to 190° C. and/or with stirring in the range from 100 to 500 rpm, preferably in the range from 200 to 400 rpm and/or for a period of 10 to 180 minutes, preferably for a period of 10 to 120 minutes. Here again, the mixing and temperature parameters will be adjusted by the person skilled in the art as a function of the selected components. The mixing and heating can be maintained for a period of time at the end of incorporation, in particular at a temperature ranging from 160 to 190° C. and/or with stirring in the range from 100 to 500 rpm, and/or for a period of 10 to 240 minutes.

Whatever the method used, the final pitch composition can correspond to the composition obtained directly at the end of step b. When the pitch composition includes one or several additives, these additive(s) may be incorporated in the pitch composition before introduction of the hydroxide or introduced after the hydroxide. When the composition includes several additives, it is, also, possible that one or other additives might already be present and that one or several additive(s) are introduced later. According to a preferred embodiment, the method according to the invention includes after step b, an additional step corresponding to the addition of an additive leading to a final pitch composition.

In particular, when the final pitch composition includes an adhesion promoter such as that described within the scope of the invention, such an adhesion promoter is, preferably, introduced in step c, subsequently to step b after introduction of the hydroxide.

In the method according to the invention, initial pitch composition refers to the composition comprising the pitch into which the hydroxide is introduced. The latter may consist entirely of pitch, a mixture of pitch with one or several additives(s) and/or a bitumen base. The components of the initial pitch compositions will be present in amounts adapted to obtain the desired amounts in the pitch composition according to the invention. Although this is not preferred, it is not excluded that the initial pitch composition includes bitumen, and in particular a hard-grade bitumen, particularly of grade 10/20 or 15/25 specified by standard 13924-1 or 20/30 or 30/45 or 35/50 specified by standard EN 12591, but in limited amounts, such that in the end, pitch represents at least 50% by weight, and preferably at least 80% by weight, and preferentially at least 90% by weight, of the total weight of the pitch composition obtained. In particular, the absence of hard-grade bitumen in the initial pitch composition makes it possible to make up just one mixture in the drum, as incorporation of the hydroxide can be carried out in-line directly.

### Compositions According to the Invention—Preferred Embodiments

The invention relates to modified pitch compositions comprising a deasphalting pitch and a hydroxide XOH such as described within the scope of the invention. Said compositions may also include one or several additives, in particular those described previously. Moreover, although these embodiments are no preferred, it is possible that the compositions according to the invention comprise a hard-grade bitumen, in particular grade 10/20 or 15/25 specified by standard 13924-1 or 20/30 or 30/45 or 35/50 specified by standard EN 12591. Preferably, when it is present, such a hard-grade bitumen represents at the most 20% by weight of the total weight of the pitch composition according to the invention.

In the pitch compositions according to the invention, the various components are distributed in the pitch. Such distribution is obtained due to mixing applied during preparation of the compositions according to the invention.

Some of the particularly preferred compositions within the scope of the invention are given hereafter. The % given are % weights, relative to the total weight of the composition. Advantageously, in the description hereafter, the first ranges cited are used together for the different components listed, or the second ranges cited for the different components listed, or the third ranges cited for the different components listed.

In particular, the invention relates to the compositions comprising the following components:
from 50 to 99.999%, preferably, from 80 to 99.998%, and preferentially from 90 to 99.99% of deasphalting pitch, and
from 0.001 to 1%, preferably, from 0.002 to 0.5%, and preferentially from 0.01 to 0.5% of hydroxide XOH in which X=Na and K; and advantageously from 0.001 to 1%, preferably, from 0.002 to 0.5%, and preferentially from 0.01 to 0.5% from soda.

According to certain embodiments, the invention relates to the compositions comprising the following components:
from 50 to 99.899%, preferably, from 80 to 99.498%, and preferentially from 90 to 98.99% of deasphalting pitch,
from 0.001 to 1%, preferably, from 0.002 to 0.5%, and preferentially from 0.01 to 0.5% of hydroxide XOH in which X=Na or K; and advantageously from 0.001 to 1%, preferably, from 0.002 to 0.5%, and preferentially from 0.01 to 0.5% of soda,
from 0.1 to 10%, preferably, from 0.5 to 8%, and preferentially from 1 to 5%, of a hydrocarbonated component CH, chosen from among hydrocarbonated oils, soft-grade bitumen, fluxed bitumen, fluidified bitumen and mixtures thereof.

According to certain embodiments, the invention relates to the compositions constituted solely of the following components:
from 89 to 99.899%, preferably, from 91.5 to 99.498%, and preferentially from 94.5 to 98.99% of deasphalting pitch,
from 0.001 to 1%, preferably, from 0.002 to 0.5%, and preferentially from 0.01 to 0.5% of hydroxide XOH in which X=Na or K; and advantageously from 0.001 to 1%, preferably, from 0.002 to 0.5%, and preferentially from 0.01 to 0.5% of soda, and
from 0.1 to 10%, preferably, from 0.5 to 8%, and preferentially from 1 to 5% of a hydrocarbonated component CH, chosen from among hydrocarbonated oils, soft-grade bitumen, fluxed bitumen, fluidified bitumen and their mixtures thereof.

According to certain embodiments, the invention relates to the compositions comprising the following components:
from 50 to 99.889%, preferably, from 80 to 99.448%, and preferentially from 90 to 98.89% of deasphalting pitch,
from 0.001 to 1%, preferably, de 0.002 to 0.5%, and preferentially from 0.01 to 0.5% of hydroxide XOH in which X=Na or K; and advantageously de 0.001 to 1%, preferably, from 0.002 to 0.5%, and preferentially from 0.01 to 0.5% of soda,
from 0.1 to 10%, preferably, de 0.5 to 8%, and preferentially from 1 to 5% of a hydrocarbonated component CH, chosen from among hydrocarbonated oils, soft-grade bitumen, fluxed bitumen, fluidified bitumen and mixtures thereof,
from 0.01 to 2%, preferably, from 0.05 to 1%, and preferentially from 0.1 to 0.3% of adhesion promoter, preferably chosen from among amines, diamines, polyamines, alkyl amido amines, amidopolyamines, imidazolines, and mixtures thereof.

According to certain embodiments, the invention relates to compositions constituted solely of the following components:
from 87 to 99.889%, preferably, from 90.5 to 99.448%, and preferentially from 94.2 to 98.89% of deasphalting pitch,
from 0.001 to 1%, preferably, from 0.002 to 0.5%, and preferentially from 0.01 to 0.5% of hydroxide XOH in which X=Na or K; and advantageously from 0.001 to 1%, preferably, from 0.002 to 0.5%, and preferentially from 0.01 to 0.5% of soda,
from 0.1 to 10%, preferably, from 0.5 to 8%, and preferentially from 1 to 5% of a hydrocarbonated component CH, chosen from among hydrocarbonated oils, soft-grade bitumen, fluxed bitumen, fluidified bitumen and mixtures thereof,
from 0.01 to 2%, preferably, from 0.05 to 1%, and preferentially from 0.1 to 0.3% of adhesion promoter, preferably chosen from among amines, diamines, polyamines, alkyl amido amines, amidopolyamines, imidazolines, and mixtures thereof.

Obviously, the pitch and the hydroxide, the adhesion promoter, and the hydrocarbonated component CH, when they are present, correspond, preferably, to those specifically described or preferred within the scope of the invention.

The compositions obtained by mixing the different components listed, in the given proportions, or even obtained by mixing only the different components listed, in the given proportions, also constitute an integral part of the invention.

### Use and Applications of Pitch Compositions According to the Invention

Various uses of the compositions according to the invention are envisaged. In particular, the compositions according to the invention can be used as a binder to replace bitumen. As a binder, a composition according to the invention can be used to prepare an association with aggregates, especially for road construction. As these are road applications, the invention concerns in particular coated aggregates as materials for the construction and the maintenance of road foundations and their surfacing, and for all road works.

By mix is meant a mixture of a binder with aggregates and possibly mineral and/or synthetic fillers. The mix comprises a composition such as described within the scope of the invention, as a binder and possibly mineral and/or synthetic fillers, preferably chosen from among fines, sand, stone chips and recycled milled products. The aggregates are mineral and/or synthetic aggregates, in particular recycled milled products, of a size greater than 2 mm, preferably between 2 mm and 20 mm.

Additionally, an object of the invention is a method for the preparation of mixes comprising hot mixing of a composition according to the invention, with aggregates, and possibly mineral and/or synthetic fillers.

A composition according to the invention, can, advantageously be used to prepare a surface coat, a hot mix, cold-poured mix or grave-emulsion. As this concerns road applications, the invention also covers asphalts as materials to make and cover pavements.

By asphalt is meant a mixture of a binder with mineral and/or synthetic fillers. An asphalt comprises a composition such as that described within the scope of the invention and mineral fillers such as fines, sand, stone chips and recycled milled products. The mineral fillers consist of fines (particles with dimensions less than 0.063 mm), sand (particles with dimensions between 0.063 mm and 2 mm) and optionally of stone chips (particles with dimensions greater than 2 mm, preferably between 2 mm and 4 mm). The asphalts show 100% compactness and are mainly used to construct and cover pavements, whereas the mixes have a compactness of less than 100% and are used to construct roads. Unlike the mixes, asphalts are not compacted with a roller when being put in place.

Thus, another objective of the invention is also a method for the preparation of an asphalt comprising the hot mixing of a composition according to the invention, with mineral and/or synthetic fillers.

Another aspect of the invention relates to the use of a composition according to the invention in various industrial applications, in particular for preparing waterproof coating, a membrane or seal layer. As regards the industrial applications of the compositions according to the invention, mention can be made of the preparation of waterproof membranes, noise-reduction membranes, insulating membranes, surface coatings, carpet tiles or seal layer.

The examples below will help illustrate the invention but without limiting it in any way.

### Reagents

The sodium hydroxide was anhydrous and its purity was in excess of 99%, it was in the form of pellets (CARL ROTH GMBH & Co. KG, Article No 9356.1).

The pitch was obtained from a vacuum distillation residue, firstly heated to 67° C., subjected to pressure of 3.4 MPa, and after performing extraction with propane, propane was added at a temperature of 36° C. Its CAS number is 91995232.

The pitch used has a CCR content of 30%, a PAH content (16 types of compounds classed as a priority by the US-EPA) of 15 ppm and a density d25° C. of 1.08, determined according to the methods cited in the description.

The adhesion promoter H1 was an amine additive: WETFIX BE from Akzo Nobel Surface Chemistry AB (CAS 68910-93-0).

The fluxed bitumen was supplied by TOTAL under the reference SOFT® BITUMEN had a kinematic viscosity at 60° C. according to standard EN 12595 of 90 mm²/s. Its transmittance, measured at 900 nm with the Hach Lange DR 3900 photometer with a 1 cm optical glass cuvette, was 0.1%.

### Evaluation of the Pitch Compositions

In the examples hereafter, the compositions were evaluated by:
measurement of needle penetration at 25° C. (abbreviation: Pene), according to standard EN 1426, the results being expressed in 1/10 mm,
measurement of the ball and ring softening temperature (abbreviation: BRT), according to standard EN 1427, the results being expressed in ° C.,
the penetration index (without units) according to standard DIN EN 1427 Appendix B,
RTFOT+PAV: The resistance of the compositions to hardening and ageing was respectively tested according to the standard DIN EN 12607-1 and standard DIN EN 12607-1 and EN 14769. The European Standard DIN EN 12607-1 specifies the method for measuring the combined effects of heat and air on a thin film of a composition in constant renewal (Rolling Thin Film Oven Test or RTFOT). The RTFOT ageing was conducted at a temperature of 163° C., for 75 minutes under air flow of 4 litres/min. The European Standard DIN EN 12607-1+EN 14769 specifies the method for accelerated long-term ageing carried out in a pressure ageing vessel (RTFOT+PAV). RTFOT ageing was carried out under the conditions given previously and those for PAV at a temperature of 100° C., for 20 hours and at a pressure of 2100 kPa.

### EXAMPLES

a) Preparation of a Hydrocarbonated Composition IC

The sodium hydroxide pellets were ground to a fine powder, using a grinder IKA® A11 (IKA-Werke GmbH & Co) at 28 000 rpm, for around 30 seconds, Thus, the sodium hydroxide (NaOH) particles were obtained. Their maximum size measured from 20 particles under the microscope was around 50 μm. At the same time, 500 g of fluxed bitumen were heated at 50° C. in a reactor with a diameter of d=16 cm and stirring at 600 rpm with hotplate stirrer (diameter D of the active mechanical part), with D/d=0.4. The temperature was controlled using a thermostat. 95.24 g of powdered sodium hydroxide was put in suspension in fluxed bitumen and stirred; stirring was continued for 30 minutes. In the composition IC obtained, % by weight of NaOH was 16%, on the basis of the total weight of the composition IC obtained. The composition IC obtained was observed by microscopy under visible light, which showed that the soda was in the form of particles over 80% of which had a maximum size less than or equal to 50 μm.

b) Preparation of the Modified Pitch Composition

The composition IC prepared previously was heated to 50° C. maximum (as the viscosity of fluxed bitumen decreases at higher temperatures, this leads to a higher decantation rate for NaOH) under stirring in a reactor with a stirrer as described in section a) (D/d=0.4) at 600 rpm for homogenising.

In parallel, 2500 g of pitch were heated at 180° C. in a reactor and stirred using a stirrer such as described in section a) (D/d=0.4) close to 400 rpm to homogenise the pitch. The prepared composition IC was added directly to the pitch (3.23 g of composition IC per 100 g of pitch=3.13% by weight in the final pitch composition). At the end of the addition of composition IC, stirring was continued for 30 minutes.

The mixture continued to be stirred for 3 hours at 600 rpm. The temperature of the mixture was set not to exceed 170° C. Samples were removed from the reactor regularly to measure the RBT and Pene. Mixing was stopped when the two stabilised. Next, the mixture was cooled down to 160° C. and 5.04 g of the adhesion promoter H1 were added. Mixing was maintained for 20 minutes. In the final pitch composition, the % by weight of NaOH was 0.500%, the adhesion promoter H1 was 0.194% by weight and fluxed bitumen 2.623% by weight, on the basis of the total weight of the pitch composition.

Table 1 below gives RBT and Pene, before and after RTFOT+PAV, for the pitch alone and for the pitch composition according to the invention.

TABLE 1

| | | | | Modified | |
|---|---|---|---|---|---|
| | | | Ref. | PITCH | Invention |
| | | | PITCH | H1 | PITCH |
| BRT | DIN EN 1427 | ° C. | 64.8 | 64.6 | 65.2 |
| Pene | DIN EN 1426 | mm/10 | 7 | 8 | 9 |
| Penetration | EN1427- | — | −1.6 | −1.5 | −1.2 |
| index | Appendix B | | | | |
| Resistance to | DIN EN 12607- | | | | |
| RTFOT | 1 + 14769 | | | | |
| and PAV | | | | | |
| ageing | | | | | |
| RBT | DIN EN 1427 | ° C. | 73.2 | 73.4 | 70.6 |
| RBT Change | DIN EN 1427 | ° C. | 8.4 | 8.6 | 5.4 |
| Pene | DIN EN 1426 | mm/10 | 6 | 6 | 8 |
| Pene | DIN EN 1426 | % | 86 | 75 | 89 |
| maintenance | | | | | |

These results show that the addition of soda makes it possible to obtain an increase in the penetration index. In particular, the penetration index obtained complies with the road construction properties as required by standard EN 1427-Appendix B. The value of −1.6, obtained in the absence of the incorporation of soda is too low and is not acceptable.

Moreover, as a supplement, the measurements carried out on a pitch modified solely by the addition of 0.194% by weight of adhesion promoter H1 (modified pitch H1) show that the stability TBA and Pene after RTFOT and PAV is less identical, possibly even less good, in the case of Pene, than that obtained for the reference pitch.

1. A pitch composition comprising a mixture of:
deasphalting pitch, which represents at least 50% by weight, and preferably at least 80% by weight, and preferentially at least 90% by weight, of the total weight of the composition, and
a hydroxide XOH with X=Na or K, which represents from 0.001 to 1% by weight, of the total weight of the composition.

2. The composition according to claim 1, comprising from 0.002 to 0.5% by weight, preferably from 0.01 to 0.5% by weight of hydroxide XOH with X=Na or K, the % being % by weight, relative to the total weight of the composition.

3. The composition according to claim 1, wherein the hydroxide XOH, with X=Na or K, forms particles which have a mean maximum size in the range from 10 to 100 μm, preferably in the range from 20 to 60 μm and/or which have a maximum size less than or equal to 100 μm, preferably less than or equal to 60 μm.

4. The composition according to claim 1, wherein the hydroxide XOH is soda.

5. The composition according to claim 1, having a penetration index determined according to standard EN 1427-Appendix B, greater than −1.5, preferably greater than or equal to −1.3.

6. The composition according to claim 1, having a needle penetration at 25° C., determined according to standard EN 1426, which falls within the range from 0 to 50 mm/10 and/or a ball and ring softening temperature, determined according to standard EN 1427, which falls within the range from 50 to 175° C.

7. The composition according to claim 1, further comprising a hydrocarbonated component CH, chosen from among hydrocarbonated oils, soft-grade bitumen, fluxed bitumen, fluidified bitumen, and mixtures thereof, said hydrocarbonated component CH preferably representing at the most 10% by weight, preferentially 0.1 to 10% by weight, in a more preferred manner 0.5 to 8% by weight, and even more preferably 1 to 5% by weight, of the total weight of the composition.

8. A method for preparing a pitch composition, comprising the following steps:
a—having an initial pitch composition available, and
b—incorporating a hydroxide XOH with X=Na or K, in an amount such that the amount of hydroxide XOH introduced represents 0.001 to 1% by weight, of the total weight of the final pitch composition obtained,
the initial pitch composition comprising an amount such that the pitch represents at least 50% by weight, preferably at least 80% by weight, and preferably at least 90% by weight, of the total weight of the final pitch composition obtained.

9. The method according to claim 8, wherein in step b, a hydrocarbonated composition IC comprising from 15 to 50% by weight of the hydroxide XOH with X=Na or K is incorporated into the initial pitch composition, said composition IC comprising a hydrocarbonated component CH, preferably chosen from among hydrocarbonated oils, soft-grade bitumen, fluxed bitumen, fluidified bitumen and mixtures thereof.

10. The method according to claim 9, wherein, the hydroxide XOH, with X=Na or K, is present in the composition IC, in the form of particles which have a mean maximum size in the range from 10 to 100 μm, preferably in the range from 20 to 60 μm and/or which have a maximum size less than or equal to 100 μm, preferably less than or equal to 60 μm.

11. The method according to claim 1, wherein the incorporation of the hydrocarbonated composition IC into the initial pitch composition is carried out at a temperature in the range from 150 to 220° C., preferably in the range from 160 to 190° C. and/or with stirring in the range from 100 to 500 rpm, preferably in the range from 200 to 400 rpm and/or for a period of 10 to 180 minutes, preferably from 10 to 20 minutes.

12. A method of increasing a penetration index determined according to standard EN 1427-Appendix B of the composition obtained, and to obtain, in particular, a penetration index greater than −1.5, preferably greater than or equal to −1.3, of a composition comprising pitch representing at least 50% by weight, preferably at least 80% by weight, and preferentially at least 90% by weight, of the total weight of the composition, by introducing a hydroxide XOH with X=Na or K into the composition, in an amount representing from 0.001 to 1% by weight, preferably from 0.002 to 0.5% by weight, and preferentially from 0.01 to 0.5% by weight, of the total weight of the composition, the % by weights given for pitch and hydroxide being calculated relative to the total weight of the composition including the hydroxide.

13. A waterproof coating, a membrane or a seal layer prepared with a composition according to claim 1.

14. A method for preparing a mix, comprising hot mixing a composition according to claim 1 with aggregates, and possibly mineral and/or synthetic fillers.

15. A mix comprising the composition according to claim 1 mixed with aggregates, and possibly mineral and/or synthetic fillers.

16. A method for preparing an asphalt, comprising hot mixing a composition according to claim 1 with mineral and/or synthetic fillers.

17. An asphalt comprising a composition according to claim 1 mixed with aggregates, and possibly mineral and/or synthetic fillers.

18. A surface coat, a hot mix, a cold mix, a cold-poured mix, a grave-emulsion or a rolling layer, prepared with a composition according to claim 1 associated with aggregates and/or recycled milled material.
